(19) United States
(12) Patent Application Publication
(10) Pub. No.: US 2004/0040799 A1
(43) Pub. Date: Mar. 4, 2004

(54) Method for actuating a parking brake system of an electromechanical brake system having both a service brake system and a parking brake system, and an electromechanical brake system

(76) Inventors: Frank Schumann, Boennigheim (DE); Georg Blosch, Murr (DE); Frank Baehrle-Miller, Schoenaich (DE)

Correspondence Address: RONALD E. GREIGG, GREIGG & GREIGG P.L.L.C., 1423 Powhatan Street, Unit One, Alexandria, VA, 22314, US

(21) Appl. No.: 10/453,487

(22) Filed: Jun. 4, 2003

(30) Foreign Application Priority Data
Jun. 4, 2002 (DE) 1 02 24 688.2

(51) Int. Cl. B60L 7/00

(52) U.S. Cl. 188/158

(57) ABSTRACT

A method for actuating a parking brake system of an electromechanical brake system that has a service brake system and a parking brake system wherein, upon actuation of the parking brake system an rpm sensor ascertains whether the vehicle is in motion, and when the vehicle is in motion to brake it to a stop with the service brake system, before the parking brake system is actuated.

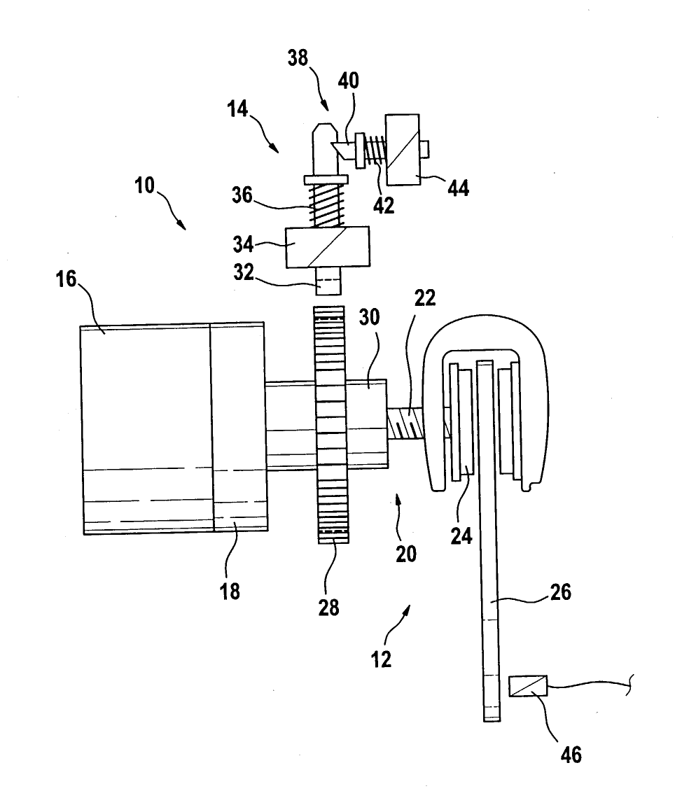

### BACKGROUND OF THE INVENTION

1. Field of the Invention

The invention relates to a method for actuating a parking brake system of an electromechanical brake system that has a service brake system and a parking brake system. The invention also relates to an electromechanical brake system for performing the method. The electromechanical brake system is intended in particular for motor vehicles.

2. Description of the Prior Art

From German Patent Disclosure DE 199 44 876 A1, an electromechanical brake system is known which has an electric motor, with which for generating a braking force, via a planetary gear as a speed-reducing gear and via a spindle drive, a friction brake lining can be pressed against a rotatable brake body.

The known brake system is embodied as a disk brake, and the brake body is a brake disk. The known brake system to this extent forms a service brake system. For embodying the parking brake system, a crown gear is provided in a manner fixed against relative rotation on a rotor of the electric motor that cooperates with a pawl. The pawl can be brought into and out of engagement with the crown gear by an electromagnet. If the pawl is meshing with the crown gear, then the rotor is held in a manner fixed against relative rotation, and thus the entire brake system is locked in its position at the time. If the pawl is out of engagement with the crown gear, the brake system can be actuated by the electromagnet, that is, can be both tightened and released. To realize the parking brake function, the brake system is tightened, and with the brake system tightened, the pawl is put into engagement with the crown gear. The braking force exerted upon tightening is maintained while the brake system is without current.

### OBJECT AND SUMMARY OF THE INVENTION

The method of the invention provides the presence of a motion sensor for an object to be braked, that is, in particular for a motor vehicle. Upon actuation of the parking brake system, a check is made by means of the motion sensor whether the object is in motion. If the object is in motion, it is braked to a stop with the service brake system, before the parking brake system is actuated. The word “stop” is also meant to encompass a slow movement of the object. The method of the invention, upon actuation of the parking brake system during travel, prevents uncontrolled braking of the vehicle and in particular locking of one or more wheels of the vehicle. An unstable driving state is averted. Driving safety is enhanced. The method of the invention is intended particularly to protect against inadvertent tripping of the parking brake system during travel, that is, if the parking brake system is tripped by mistake by someone in the vehicle, or if there is an electrical/electronic failure. It is understood that a vehicle or other object to be braked can also be braked intentionally to a stop by tripping the parking brake system.

To increase the availability two motion sensors may be provided. This provides redundance, and incorrect measurements or a defective motion sensor can be detected and corrected, or ignored.

When the method of the invention is performed in a vehicle, in particular a motor vehicle, one or more rpm sensors may be used as a motion sensor or motion sensors, since rpm sensors are normally already present in modern motor vehicles.

The electromechanical brake system of the invention is designed for performing the method discussed above. It has a service brake system and a parking brake system, and with the parking brake system, the service brake system can be locked in the actuated or in other words tightened position. For actuating the parking brake system, first the service brake system is actuated, and when the object to be braked is at a stop, the service brake system is locked in the actuated position, using the parking brake system. If the object is moving upon actuation of the parking brake system, then the object is first braked to a stop using the service brake system, before the parking brake system is actuated. The parking brake system has an releasable locking device which normally keeps the parking brake system locked in a released position and enables it only after unlocking. The locking device increases the security of the brake system against inadvertent actuation of the parking brake system.

An electromagnet may be employed for unlocking the locking device, and an electromagnet may also be employed for actuating the parking brake system.

A refinement provides a free-wheel of the parking brake system, which allows an actuation of the service brake system when the parking brake system has been actuated and blocks against release of the parking brake system. As a result, tightening of the service brake system is possible even with the parking brake system actuated.

### BRIEF DESCRIPTION OF THE DRAWINGS

The invention will be better understood and further objects and advantages thereof will become more apparent from the ensuing detailed description of a preferred embodiment taken in conjunction with sole the drawing FIGURE which is a schematic illustration of a brake system according to the invention.

### DESCRIPTION OF THE PREFERRED EMBODIMENT

The electromechanical brake system 10 of the invention, shown in the drawing, is intended for use in a motor vehicle, not shown. The brake system 10 has a service brake system 12 and a parking brake system 14. The service brake system 12 includes an electric motor 16, with which a spindle drive 20 can be driven to rotate via a speed-reducing gear 18. For a compact, space-saving construction of the brake system 10, the electric motor 16 can be embodied as a hollow-shaft motor, in whose hollow shaft (rotor) the speed-reducing gear 18, preferably in the form of a planetary gear, and/or the spindle drive 20 is accommodated. This kind of construction of an electromechanical vehicle brake system is known per se and, since it is not the actual subject of the invention, will not be described in detail here. The spindle drive 20 converts the rotary motion of the electric motor 16 into a translational motion, namely an axial displacement of a spindle 22 of the spindle drive 20. With the spindle, for generating a braking force, a friction brake lining 24 can be pressed against a rotating brake body, such as a brake disk 26.

For embodiment as a parking brake system 14, the brake system 10 has a gear wheel 28, which is connected in a manner fixed against relative rotation to a rotor of the electric motor 16. Cooperating with the gear wheel 28 is a locking bar 32, which is disposed radially to the gear wheel 28 and is displaceable radially to the gear wheel 28. By means of an electromagnet 34, the locking bar 32 can be brought into engagement with teeth of the gear wheel 28. The teeth of the gear wheel 28 are sawtooth-shaped, and one end of the locking bar 32, oriented toward the gear wheel 28, is shaped in complementary form. As a result, when the locking bar 32 is in engagement with the gear wheel 28, the gear wheel 28 and the locking bar 32 form a ratchet, that is, a free-wheel. The gear wheel 28 and together with it the rotor of the electric motor 16 are rotatable in one direction and are blocked against rotation in the other direction of rotation when the gear wheel 28 and locking bar 32 are engaged. The direction of rotation is selected such that further tightening of the brake system 10, that is, pressing the friction brake lining 24 against the brake disk 26, is possible. If the locking bar 32 is out of engagement with the gear wheel 28, the gear wheel 28 and the rotor of the electric motor 16 are freely rotatable in both directions of rotation; the brake system 10 can be tightened and released. Instead of a ratchet, some other known type of free-wheel (not shown) can also be selected.

In the drawing, for the sake of clarity, the gear wheel 28 is shown mounted on the nut 30 of the spindle drive 20, instead of being connected in a manner fixed against relative rotation to the rotor, not visible in the drawing, of the electric motor 16. Both embodiments are possible. However, a connection of the gear wheel 28 to the rotor of the electric motor 16 in a manner fixed against relative rotation has the advantages that the brake system 10 can be locked in a more finely graduated way, and that the torque at the rotor of the electric motor 16 is less because of the intervening speed-reducing gear 18. It is therefore preferable that the gear wheel 28 be mounted on the rotor of the electric motor 16.

A spring element 36 normally puts the locking bar 32 out of engagement with the gear wheel 28 and keeps it that way, while supplying electric current to the electromagnet 34 puts the locking bar 32 into engagement with the gear wheel 28.

A locking device 38 is also provided, which has a second locking bar 40, which by means of a spring element 42 is moved into engagement with the first locking bar 32 and which can be brought out of engagement with the first locking bar 32 by an electromagnet 44, counter to the force of the spring element 42. If the second locking bar 40 is in engagement with the first locking bar 32, then the second locking bar 40 acts as a safety device by blocking the first locking bar 32 against being brought into engagement with the gear wheel 28. As a result, inadvertently supplying current to the electromagnet 34 of the first locking bar 32 is prevented from bringing the first locking bar 32 into engagement with the gear wheel 28. Before the first locking bar 32 can be brought into engagement with the gear wheel 28, the second locking bar 40 must be brought by the electromagnet 44 out of engagement with the first locking bar 32.

If the first locking bar 32 is in engagement with the gear wheel 28, and if there is no current to the electromagnet 44 of the second locking bar 40, then the spring element 42 of the second locking bar 40 keeps the second locking bar 40 in engagement with the first locking bar 32, so that the spring element 36 of the first locking bar 32 does not put the first locking bar 32 out of engagement with the gear wheel 28. As a result, when there is no current to the electromagnets 34, 44, the first locking bar 32 continues to be in engagement with the gear wheel 28 and prevents a release of the brake system 10 even if it is not being supplied with electric current. By supplying the electromagnet 34 of the first locking bar 32 with current, the spring force of the spring element 42 of the second locking bar 40 can be overcome and can put the second locking bar 40 out of engagement with the first locking bar 32, so that it is possible to put the first locking bar 32 out of engagement with the gear wheel 28 by supplying current to only the electromagnet 34 of the first locking bar 32, and without supplying current to the electromagnet 44 of the second locking bar 40.

The brake system 10 of the invention further has at least one motion sensor in the form of an rpm sensor 46, which is associated with a vehicle wheel. For the sake of redundance, rpm sensors 46 are preferably provided on a plurality of vehicle wheels.

The method of the invention provides that upon actuation of the parking brake system 14, it is ascertained by means of the rpm sensor 46 whether the vehicle is in motion. If the vehicle is not in motion, supplying current to the electric motor 16 causes the service brake system 12 to be actuated or in other words tightened up to a predetermined parking braking force. Next, supplying current to the electromagnet 44 of the second locking bar 40 puts the second locking bar 40 out of engagement with the first locking bar 32, and supplying current to the electromagnet 34 of the first locking bar 32 puts the first locking bar into engagement with the gear wheel 28. The gear wheel 28, and together with it the rotor of the electric motor 16, the speed-reducing gear 18, and the nut 30 of the spindle drive 20, are as a result blocked against rotating in the direction of releasing the brake system 10; the parking braking force is maintained while there is no current to the electric motor 16. The supply of current to the electromagnet 44 of the second locking bar 40 is ended, and as a result the spring element 42 of the second locking bar 40 puts the second locking bar 40 into engagement with the first locking bar 32 and thus keeps the first locking bar 32 in engagement with the gear wheel 28, counter to the force of its spring element 36. The current supply to the electromagnet 34 of the first locking bar 32 is now ended as well; the parking braking force that has been built up is maintained while the brake system 10 is without current.

If the vehicle is in motion upon actuation of the parking brake system 14, then at first, only the service brake system 12 is actuated when current is supplied to the electric motor 16, and so a predetermined braking force, which can differ from the parking braking force, is built up. The vehicle is braked down to a stop. Next, the parking brake system 14 is actuated in the manner described above.

The foregoing relates to a preferred exemplary embodiment of the invention, it being understood that other variants and embodiments thereof are possible within the spirit and scope of the invention, the latter being defined by the appended claims.

We claim:

1. A method for actuating a parking brake system of an electromechanical brake system of a vehicle, the system having a service brake system and a parking brake system, the method comprising
providing a motion sensor (46) for an object to be braked,
actuating the service brake system (12) when the object is in motion until the object comes to a stop, and
actuating the parking brake system (14) only when the motion sensor (46) indicates that the object is at a stop.

2. The method of claim 1, comprising utilizing at least two motion sensors (46) one each on different vehicle wheels.

3. The method of claim 1, wherein the motion sensor is an rpm sensor (46).

4. An electromechanical brake system of a vehicle, the system comprising
a service brake system
a parking brake system,
the parking brake system being operable to lock the service brake system in the actuated position,
the parking brake system (14) including a releasable locking device (38) normally keeping the parking brake system (14) locked in a released position and enables the parking brake system only after unlocking.

5. The electromechanical brake system of claim 4, wherein the locking device (38) comprises an electromagnet (44), with which it is unlockable.

6. The electromechanical brake system of claim 4, wherein the parking brake system (14) comprises an electromagnet (34), with which it is actuatable.

7. The electromechanical brake system of claim 4, wherein the parking brake system (14) further comprises a free-wheel (28; 32), the free-wheel being operable when the parking brake system (14) is actuated to allows an actuation of the service brake system (12) and to block against release of the parking brake system (14).
